(19) United States
(12) Patent Application Publication
(10) Pub. No.: US 2023/0016988 A1
(43) Pub. Date: Jan. 19, 2023

(54) Torque Transmitting Elements for Coupling

(71) Applicant: Dodge Acquisition Co., Oxford, CT (US)

(72) Inventors: Thomas E. Kuckhoff, Greenville, SC (US); Anindo Banerjee, Manteca, CA (US)

(73) Assignee: Dodge Acquisition Co., Oxford, CT (US)

(21) Appl. No.: 17/374,462

(22) Filed: Jul. 13, 2021

(51) Int. Cl. F16D 3/12; F16D 3/06

(52) U.S. Cl. CPC F16D 3/12; F16D 3/06; F16D 2200/0004; F16D 2200/006; F16D 2200/0034; F16D 2200/0056; F16D 2300/12; F16D 2300/22

(57) ABSTRACT

A coupling assembly for transmitting rotational forces from a driving shaft to a driven shaft, the driving and driven shafts having teeth. The coupling assembly includes a first and a second flange, each flange configured to be rotationally fixed onto respective shafts. A pair of resilient shoes are disposed between the flanges. The shoes are configured to be attached to the coupling assembly by a first plurality of fasteners that are fixed to the first flange and extend through the shoes to connect the shoes to the first flange and a second plurality of fasteners are fixed to the second flange and extend through the shoes to connect the shoes to the second flange.

### FIELD OF THE DISCLOSURE

The present disclosure relates to power transmission and, more particularly, to mechanical power transmission using flexible or elastic couplings.

### BACKGROUND

Couplings for connecting driving and driven mechanical components, typically in the form of rotating shafts are known. For industrial and residential equipment to transfer mechanical rotational energy couplings are integrated into the equipment design. For example, a coupling is used to connect an electric motor shaft to a fluid pump driver shaft which moves liquid from one point to another.

Due to limitations of current coupling designs, couplings which can transmit large amount of mechanical energy (hereafter referred to as torque), in a small overall footprint, requires the use of lubricant for proper operation and an acceptable operating life, and are typically made of steel. The use of lubrication is required because non-static joints which experience sliding and/or rubbing between metallic surfaces within the coupling due at least to imperfectly aligned joined rotating shafts. Lubrication requires extensive maintenance, extended installation duration, and limited applications for users of these couplings.

Couplings with high torque density value either require high precision machined steel components and/or lubrication of steel components, such as those found in a grid coupling. Where torque density is defined as the amount of torque per diametrical size of the coupling. For example, a coupling with a low torque transmission rating and a large diameter would have a smaller torque density then that of a high torque transmission rating and a small diameter. Large torque density is beneficial as the cost of the coupling is directly proportional to the overall size of the coupling. The larger the coupling the larger the weight of the coupling, which effects the power transmission application through larger rotational inertia in the system and proper lifting requirements for maintenance and installation, both of which require additional safety measures for proper operation. Furthermore, large couplings require a corresponding amount of raw materials to manufacture, which has a corresponding cost.

Metallic style lubricated couplings require consistent maintenance as the life of the coupling is dependent on the life of the lubrication inside the coupling. Maintenance of the coupling requires an additional investment by the user of the coupling as large torque dense couplings are usually placed in locations away from easy accessibility. This is a result of the amount of torque the application generates (such as being internal to a larger equipment assembly) and maintaining proper OSHA guarding from the coupling and equipment.

Metallic style couplings are not resistant to shock loading in the power transmission system. Shock loading occurs when the coupling experiences an increase in torque greater than a nominal application value. An example of shock loading is at start-up when the driven equipment is under load. This results in the peak load temporarily being so great that it damages the rigid design of the coupling. Therefore, causing it to fail prematurely.

While the current coupling market does offer high torque dense couplings, users must pay a high price due to the machining of the steel, must constantly maintain the lubrication of the coupling, and often replace the coupling when shock loading is accidentally applied to the element.

Elastomeric couplings are uniquely suited for use in applications where shock, vibration and misalignment may be present. In these types of couplings, driving and driven metal or otherwise stiff hubs are connected on either side of a transmission junction and are connected to one another using an elastomeric or yielding material such as EPDM, Neoprene, Hytrel® and the like. In this way, the yielding material can provide flexing along three axes to accommodate torsional, angular, and parallel misalignment, and also torque spikes and impact drive loads.

A few examples of such flexible sleeve couplings can be seen in U.S. Pat. Nos. 2,867,102 and 2,867,103 (the Williams references), which issued in 1956 and 1957, respectively, and describe a flexible coupling for shafts and a gripping arrangement for flexible couplings for power transmission shafts. The types of couplings described in the Williams references are widely used in various industries, but their applications are not without known issues and limitations.

There is a need therefore, for couplings that possess the ability to transfer large amounts of torque from a drive shaft to a driven shaft in a compact form, is able to tolerate relatively greater amounts of angular misalignment, is resistant to shock loads, and isolates any damage to inexpensive and are constructed of easily replaceable elements. Devices according to the present disclosure satisfy the need.

### BRIEF SUMMARY OF THE DISCLOSURE

In one aspect, the present disclosure describes a coupling. The coupling includes a coupling assembly for transmitting rotational forces between a driving shaft and a driven shaft, the driving and driven shafts having teeth for attachment of the coupling assembly thereto, the coupling assembly including a first flange and a second flange sized and shaped to be positioned radially outwardly with respect to the driving shaft and driven shaft respectively. The flanges have a plurality of teeth on an inner portion thereof configured to respectively engage with the teeth of the driving and driven shaft so as to rotationally fix the flanges to the shafts. A pair of elastomeric shoes are disposed between the first flange and second flange. The pair of elastomeric shoes are configured to be attached to the coupling assembly by way of a first plurality of fasteners that are fixed to the first flange and extend through the pair of elastomeric shoes to connect the pair of elastomeric shoes to the first flange and a second plurality of fasteners that are fixed to the second flange and extend through the pair of elastomeric shoes to connect the pair of elastomeric shoes to the second flange. The pair of elastomeric shoes are thereby configured to transmit torque from the first flange to the second flange and permit misalignment between the drive shaft and the driven shaft.

In yet another aspect, the disclosure describes a resilient shoe for transmitting rotational forces between flanges of a coupling assembly fixed to a driving shaft and a driven shaft, the shoe including an arcuate body made of an elastomeric material. A plurality of spaced-apart holes are formed through the shoe, the plurality of holes provided in an odd number. A sleeve is disposed in each of the plurality of holes, each sleeve configured to receive a fastener therethrough and configured to reinforce the one of the pluralities of holes in which it is disposed and a framework is disposed in the elastomeric material configured to be placed in tension or compression in response to torque transmitted through the coupling assembly.

BRIEF DESCRIPTION OF THE SEVERAL VIEWS OF THE DRAWINGS

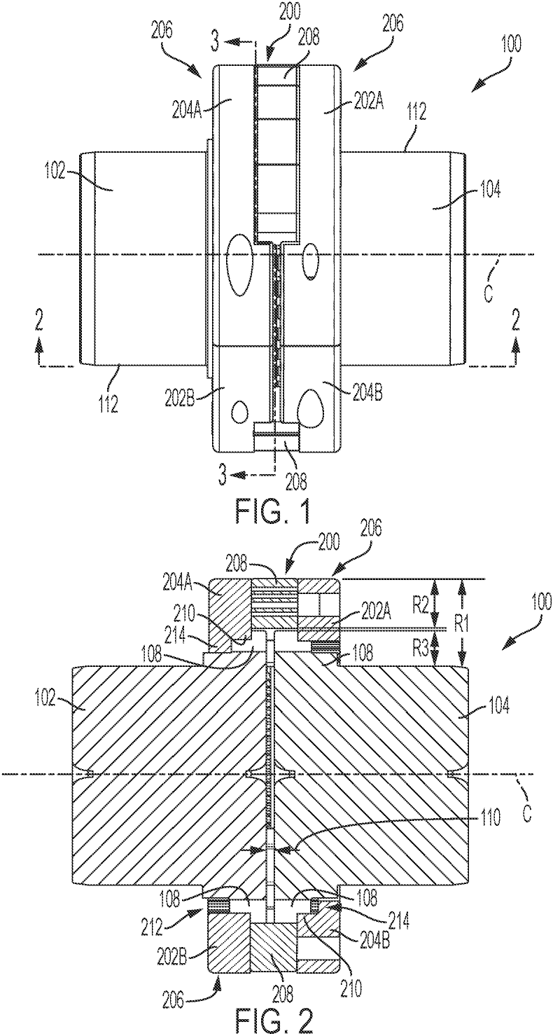

FIG. 1 is an outline view from a side perspective of a coupling in accordance with the disclosure.

FIG. 2 is a section view of the grid coupling of FIG. 1.

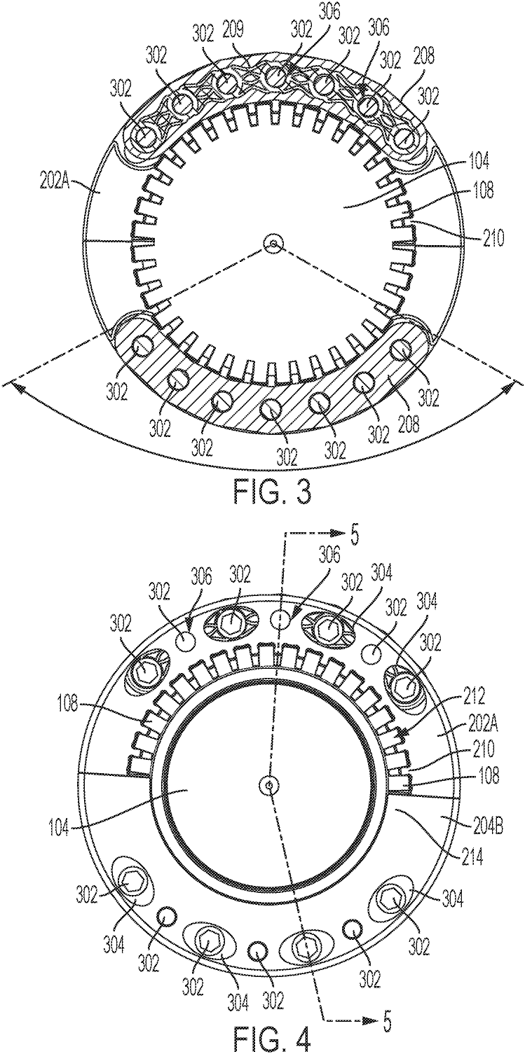

FIG. 3 is a partially disassembled and sectioned view through a portion of the grid coupling of FIG. 1.

FIG. 4 is an outline view from a rear perspective of the grid coupling of FIG. 1.

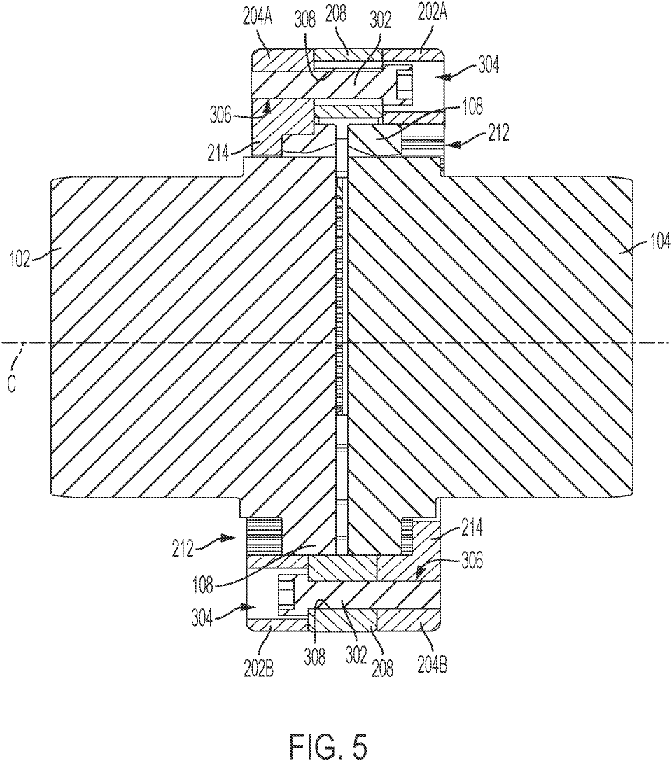

FIG. 5 is a section view through the grid coupling of FIG. 1.

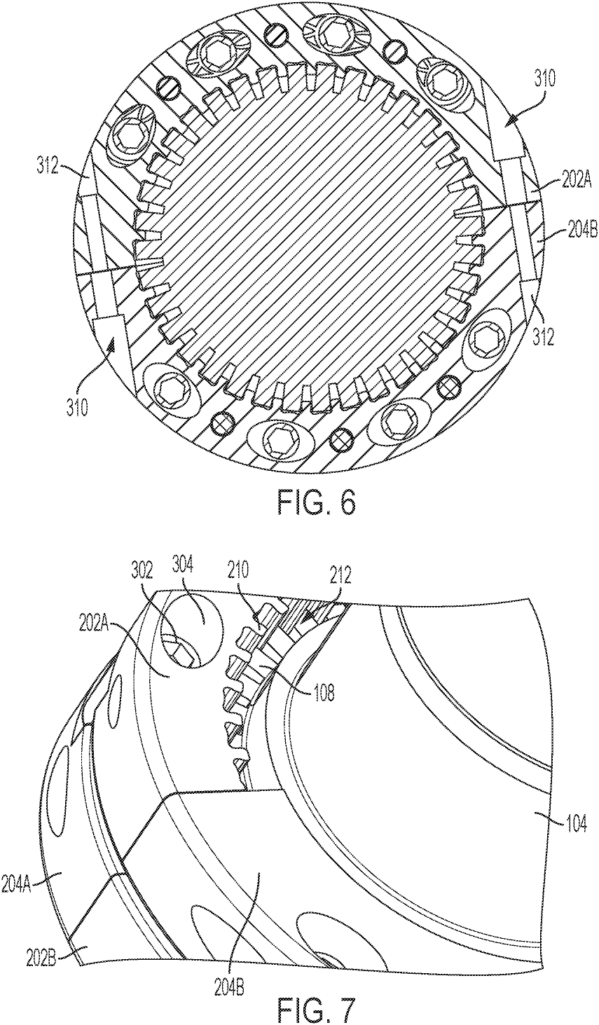

FIG. 6 is a section view through a portion of the coupling of FIG. 1.

FIG. 7 is an enlarged detail view of a portion of the coupling of FIG. 1.

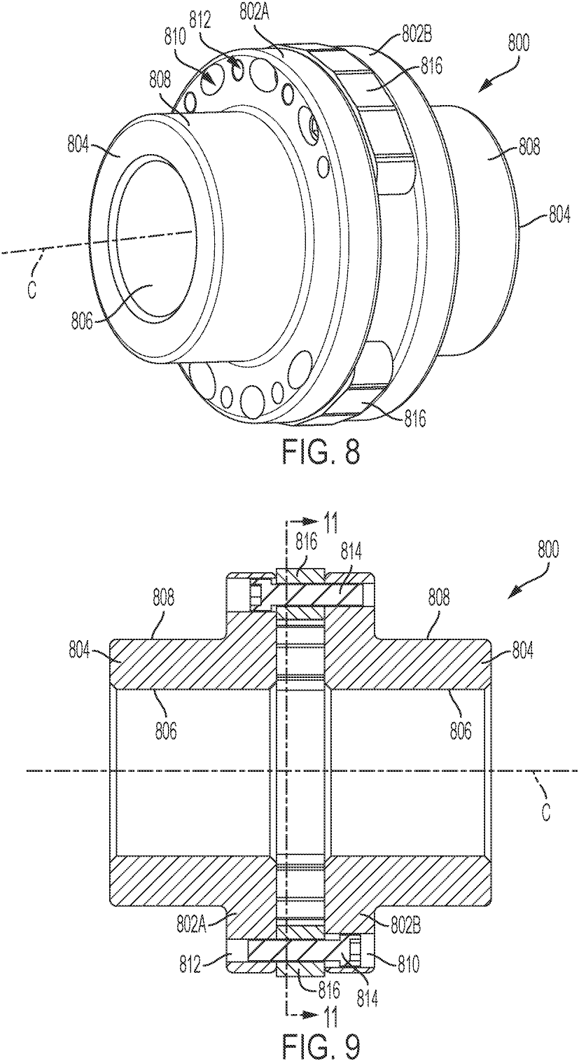

FIG. 8 is an outline view of an alternative embodiment for a grid coupling in accordance with the disclosure.

FIG. 9 is a sectional view of the grid coupling of FIG. 8.

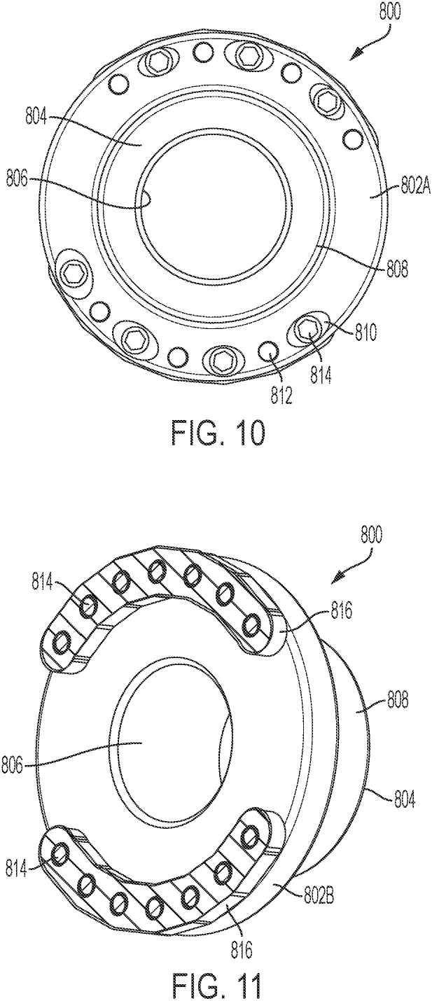

FIG. 10 is an outline view from a front perspective of the grid coupling of FIG. 8.

FIG. 11 is a partially sectioned view of the coupling of FIG. 8.

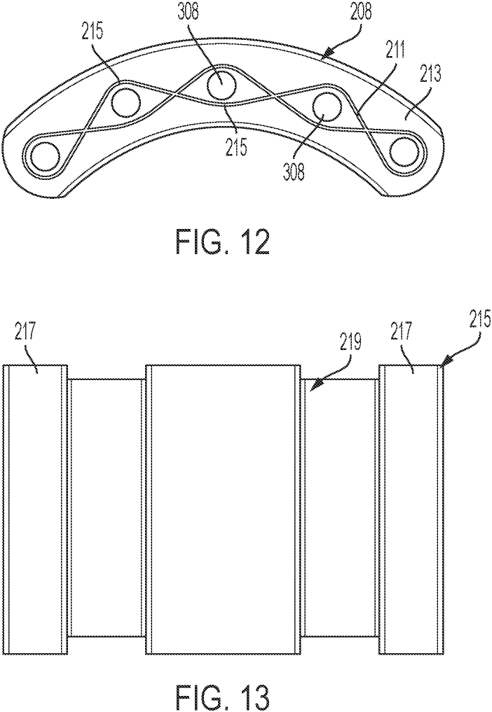

FIG. 12 is a section view of a shoe according to an embodiment thereof.

FIG. 13 is a side view of a sleeve for a shoe.

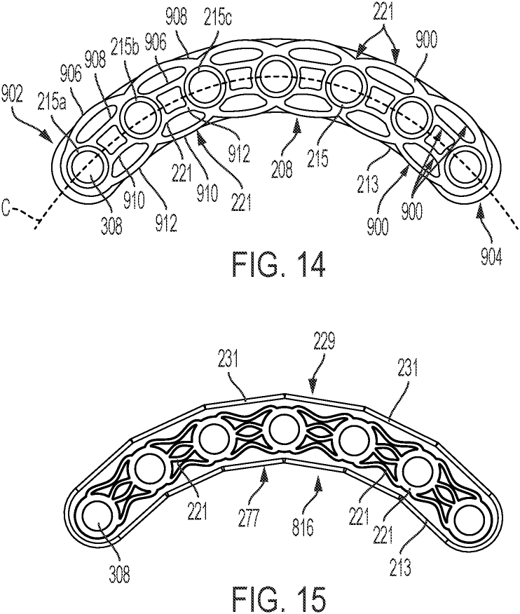

FIG. 14 is a section view of a shoe according to another embodiment thereof.

FIG. 15 is a section view of a shoe according to yet another embodiment thereof.

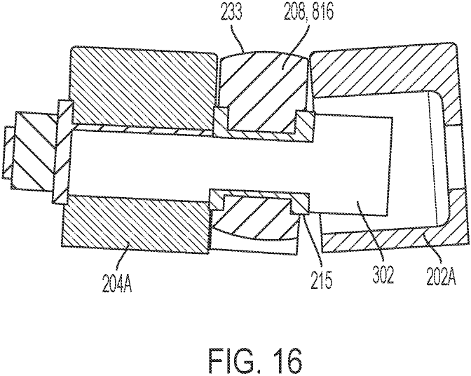

FIG. 16 is a close-up sectional view of a shoe in a coupling assembly showing in an angular misalignment.

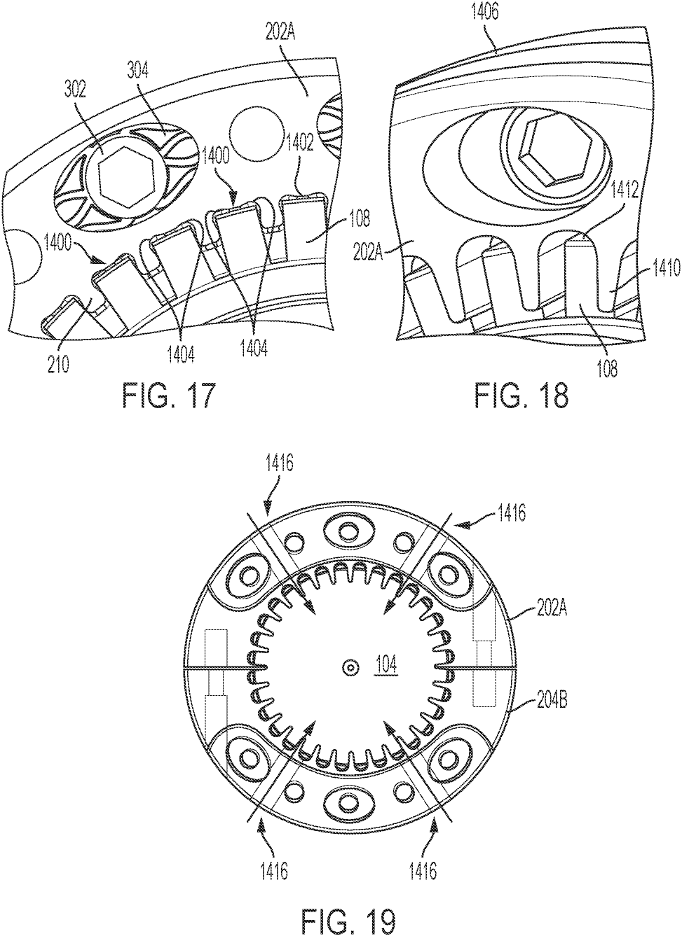

FIG. 17 is a close-up view of a portion of a grid coupling in accordance with an embodiment of the disclosure.

FIG. 18 is a close-up view of a portion of a grid coupling in accordance with an alternative embodiment of the disclosure.

FIG. 19 is a section view through a portion of a grid coupling in accordance with an alternative embodiment of the disclosure.

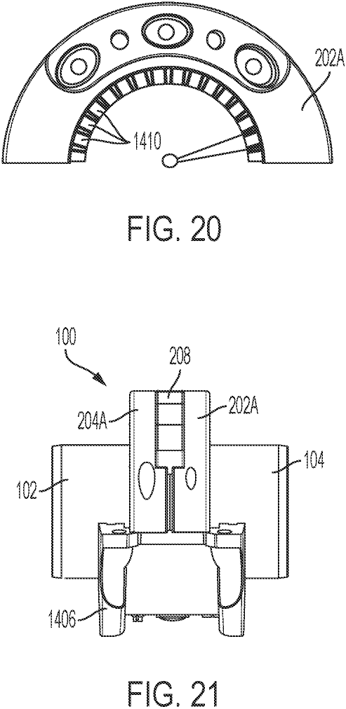

FIG. 20 is a side view of a flange portion in accordance with the disclosure.

FIG. 21 is a side view of a coupling having a portion of a housing in accordance with the disclosure.

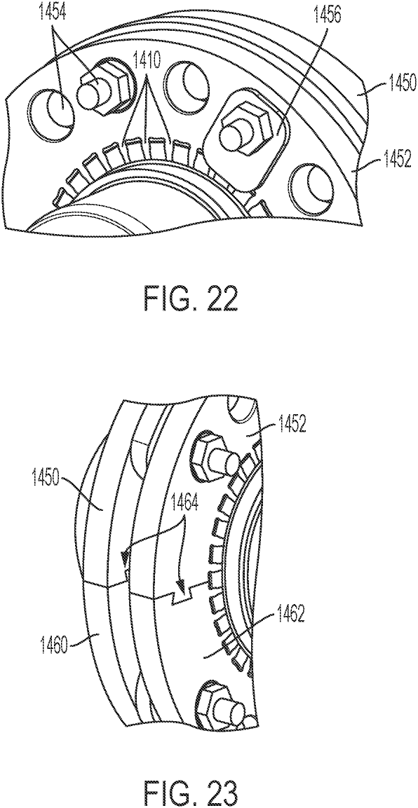

FIG. 22 is a close-up view of a portion of an embodiment for a grid coupling flange retention structure in accordance with the disclosure.

FIG. 23 is a close-up view of a portion of an embodiment for a flange connection arrangement in accordance with the disclosure.

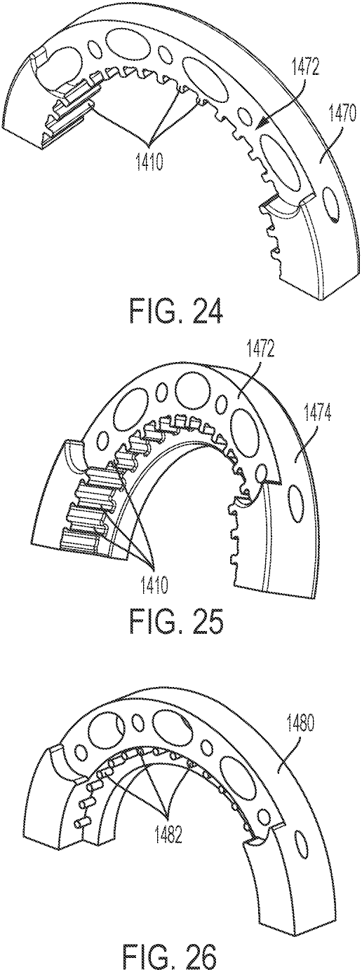

FIGS. 24, 25 and 26 are alternative embodiments for flange sections for a grid coupling in accordance with the disclosure.

### DETAILED DESCRIPTION

In the description that follows, structures, elements and/or features that are the same or similar will be referred to with the same reference characters.

Features of couplings according to the disclosure will now be described in additional detail. A coupling 100, which can also be referred to as a grid coupling for historical purposes for the type of coupling it replaces and improves upon, is shown from a side perspective in FIG. 1 and in section view in FIG. 2. In reference to these figures, the coupling 100 is connected between first and second splined shafts 102 and 104. Each of the splined shafts 102 and 104 includes a splined portion 106 that forms a plurality of teeth 108 extending peripherally outwardly with respect to central axis, C, the teeth in the plurality of teeth 108 extending peripherally around an end portion of each shaft 102, 104 and being in opposed relation such that the pluralities of teeth 108 of the shafts 102 and 104 are disposed adjacent to one another across a gap 110 defined axially along the central axis C between the two shafts 102, 104. For purposes of this disclosure, splines and teeth may be used interchangeably at least with respect to the engageable torque-transmitting features of each shaft or hub.

A coupling assembly 200 is disposed to torsionally interconnect or mesh the splined ends of the two shafts 102, 104. As shown, the coupling assembly 200 includes sets of flange portions 202, 204, which are connectable to one another and when connected together form an annular flange 206 disposed around the end of each shaft 102, 104. Each of the flange portions 202, 204 may be generally semi-circular in shape, or may be considered to be configured to form half of the annular flange 206. In alternative embodiments, the assembly 200 may be formed of flange portions formed of two or more parts. Each annular flange 206 extends radially outwardly with respect to each shaft 102, 104 and the pluralities of teeth 108 by a distance, R1, with respect to an outer cylindrical surface 112 of the respective shaft 102, 104. Disposed between the two flanges 206 are two resilient/elastic torque transmitting elements or shoes 208, each having a radial thickness, R2, which is less than R1 and which is sufficient to span at most a radial distance that is less than a difference between R1 and a radial height R3 of the pluralities of teeth 108, as shown in FIG. 2. Also, each of the shoes 208 may form a minor arc, i.e., less than 180 degrees, and in one embodiment more than 90 degrees. While two shoes 208 are illustrated, it will be understood that the disclosure contemplates two or more shoes, where in the case of more than two shoes the size of the multiple shoes are each adapted to fit in the same general configuration.

Each flange portion 202 and 204, and thus each of the annular flanges 206 forms teeth 210 along an inner portion thereof, as explained below, which mesh with the plurality of teeth 108 on the respective shaft 102, 104 to rotatably engage each flange 106 with its respective shaft 102, 104. It will be understood that the teeth 210 formed on the flange portions 202, 204 may be any suitable configuration that mesh with the torque-transmission features of the shafts 102, 104.

Fasteners extending through one of the flanges 206, through the resilient shoes 208, and being threadably engaged with the other flange 206 torsionally and rotatably engage or couple the two shafts 102 and 104 for rotation about the central axis, C. It should be appreciated that misalignments can cause the two shafts 102 and 104 to rotate at an angled axis relative to the central axis C, which is shown straight in FIG. 2 for sake for discussion and illustration.

To illustrate the fastener connection between the two flanges 206, reference is made to FIGS. 3, 4, and 5. In FIG. 3, a partial section is shown through the coupling 100 in which one of the resilient shoes 208 is sectioned to show internal structures. In FIG. 4, an outline view is shown from an end perspective to show the orientation of fasteners. In FIG. 5, a non-symmetrical diameter section is taken through two opposed fasteners to show their orientation. In reference to these figures, it can be seen that each flange portion 202 and 204 includes threaded and through holes formed in alternating fashion to accommodate the heads or threads of fasteners 302 disposed through one flange portion and threadably engaged through a corresponding opposite flange portion in mating the two sides of the coupling assembly 200.

More specifically, and as is also shown in FIGS. 1 and 2, the coupling assembly includes two flange portions 202, and two flange portions 204. For sake of discussion, and consistent with the illustrated embodiment, the flange portions can be formed in two varieties that cooperate with one another. In reference to FIG. 2, it can be seen that a first variety of flange portion or thru-flange portion 202 includes a thru-bore 212 around the pluralities of teeth 108 that permits the thru-flange portion 202 to slide uninterrupted over and, if desired, past the teeth 108 in an axial direction along the axis, C. The thru-flange portion 202 is mated with a second variety of flange portion or a stop flange portion 204, which includes a stop wall 214 that blocks the axial motion of the stop flange portion 204 in the axial direction along the axis C when the wall 214 abuts the outer axial end of the plurality of teeth 108.

Each pair of a thru-flange portion 202 and a stop flange portion 204 (two total) that are used in the coupling assembly are mated together or engaged with bolts in an axial direction, and are also arranged in opposite axial orientation, as shown in FIG. 2, such that each thru-flange portion 202 is engaged with two stop flange portions 204 (A and B), one axially and the other peripherally, and each stop-flange portion 204 is engaged with two thru-flange portions 202 (A and B), one axially and the other peripherally to form the coupling assembly 200. The stop flange portions 204 ensure that coupling is positively engaged in the axial directions for ease of proper installation and robustness. The resilient shoes 208 are disposed, one each, between each axially engaged pair of thru-flange portions 202 and stop flange portions 204.

Due to minor structural differences, which are described below, a first pair of flange portions in the axial direction includes one thru-flange 202A and one stop flange 204A, and a second pair of flange portions in the axial direction includes one thru-flange 202B and one stop flange 204B, as denoted in FIGS. 1 and 2. In this arrangement, the thru-flange 202A is axially engaged with a stop flange 204A and is also peripherally engaged with a stop flange 204B. Similarly, the thru-flange 202B is axially engaged with the stop flange 204B and is also peripherally engaged with the stop flange 204A. The stop flange 204A is axially engaged, through a resilient shoe 208, to the thru-flange 202A and is also peripherally engaged with the thru-flange 202B. Finally, the stop flange 204B is axially engaged, through a resilient shoe 208, with the thru-flange 202B and is also peripherally engaged with the thru-flange 202A.

In reference now to FIGS. 3, 4 and 5, it can be seen that the thru-flange portion 202A on the top half of the figure includes seven fastener openings, of which four are oval shaped, through bore openings 304 and three are threaded openings 306. This arrangement allows for each fastener 302 (FIG. 5) to be inserted in one axial direction or the other through the bore openings 304 in the thru-flange portion 202A to threadably engage threaded openings 306 formed in the stop flange portion 204A, or through corresponding bore openings 304 in the stop flange portion 204A to threadably engage the threaded openings 306 in the thru-flange portion 202A. It will be understood that according to alternative embodiments, the number of openings, and corresponding fasteners, may be any suitable odd number or prime number, for example. The arrangement and number of the openings provides a properly balanced configuration.

Similarly, as shown in FIG. 4, the stop flange portion 204B forms seven fastener openings, of which four are through bore openings 304 and three are threaded openings 306. This arrangement allows for each fastener 302 (FIG. 5) to be inserted in one axial direction or the other through the bore openings 304 in the stop flange portion 204B to threadably engage threaded openings 306 formed in the thru-flange portion 202B, or through corresponding bore openings 304 in the thru-flange portion 202B to threadably engage the threaded openings 306 in the stop flange portion 204B.

In each case, the fasteners 302 interconnecting the flange portions pass through bores 308 formed in the resilient shoes 208. Each resilient shoe 208 forms seven bores 308 in the embodiment shown, which accommodate the seven fasteners 302 (four inserted in one axial direction, and three in the other) interconnecting the flange portion pairs, i.e. the thru-flange portion 202A with the stop flange portion 204A, and also seven more (four in one direction and three in the other) to connect the stop flange portion 204B with the thru-flange portion 202B. As can be appreciated, depending on the diameter size of the coupling and size of the fasteners more or fewer fasteners can be used. As shown in FIG. 3, where a partial section is taken through the top resilient shoe 208, each shoe may be made from a molded rubberized or otherwise resilient material over a matrix of structural elements 209, which may be more rigid than the over molded resilient material to form a composite structure having improved stiffness over a purely resilient shoe, which may be selectively required depending on application.

By inserting the same number of fasteners 302 in each axial direction to engage the axial flange portion pairs (A and B), a balanced loading on the shoes can be maintained in a diametrical and/or radial direction around the coupling assembly 200 and across the two shafts 102 and 104. In one embodiment, fasteners extending through a bore 310 and a threaded opening 312 extending tangentially relative to the shafts 102 and 104 peripherally connect the flange portions, specifically, the stop flange portion 204A with the thru-flange portion 202B and the thru-flange portion 202A with the stop flange portion 204B. As can be seen in FIG. 6, to preserve loading balance in a peripheral direction, the fasteners are oriented in two axially opposed directions that are parallel and tangentially related in diametrically opposite locations around a diameter of the shafts 102 or 104.

A close-up view of a portion of an interface between the thru-flange portion 202A and the stop flange portion 204B is shown in FIG. 7. In reference to this figure, it can be seen that the bore openings 304 have a generally elongated or elliptical shape that accommodates the head of the fastener 302. The bore 212 is open, and previously described, and the teeth 210 extend the entire length axially of the bore 212.

An alternative embodiment of a coupling 800 is shown in FIG. 8. The coupling 800 structurally differs from the coupling 100 in that in is configured to attach and torsionally connect the ends of two smooth shafts (not shown), i.e., shafts that do not include hubs having teeth formed thereon as was the case with the shafts 102 and 104 (FIG. 2). In this embodiment, the coupling includes solid collars that are disposed on the hubs, each of which forms a flange. The two flanges are then connected using resilient shoes and fasteners providing a balanced load between the two flanges, similar to the coupling 100.

More specifically, the coupling 800 includes two flanged collars 802A and 802B. Each flanged collar 802A and 802B includes a collar portion 804 which is engageable onto the free end of a shaft (now shown), for example, by an interference or thermal shrink fit, or nay alternatively include anti-rotation features such as keys, set screws and the like, in the known fashion (none of which are shown here for simplicity). The collar portion 804 includes an inner bore 806, into which the shaft (not shown) is inserted, and an outer cylindrical surface 804. At ends facing one another, each collar portion 804 forms the flanged collars 802A and 802B. Each flanged collar 802A and 802B has a flat, annular shape that extends radially outwardly from the cylindrical surface 804. Each flanged collar 802A and 802B further includes through openings 810 and threaded openings 812 that accommodate therein fasteners 814, as shown in FIG. 9, which is a cross section view through the coupling 800. As can be seen from FIG. 8, the fasteners 814 are arranged to be installed in alternating axial directions or orientations between the two flanged collars 802A and 802B, in a similar configuration as in the coupling 100, to provide a balanced loading, as is also shown in FIG. 10, which is a perspective rear view of the coupling 800. Also similar to the coupling 100, two resilient shoes 816 are disposed between the exposed, flat annular faces of the flanged collars 802A and 802B.

As shown in FIG. 9, the fasteners extend in one axial direction or the other relative to a centerline, C, through a through opening 810, through a bore formed in the resilient shoe 816, and into the threaded opening 812, where they engage the respective one of the flanged collars 802A and 802B and are tightened to clamp the flange collars 802A and 802B together and the resilient element 816 between them. As is also shown in FIG. 11, seven fasteners connect the two flanged collars 802A and 802B together on either diametrical end, for a total of 14 fasteners and two resilient shoes to complete the coupling 800, but more than two segments, and fewer or more than 14 fasteners can be used depending on the size and configuration of the coupling 800. The resilient shoes 816 may also include reinforcements internally and be formed as composite structures similar to the shoes 208 having ribs 209, as shown in FIG. 3.

FIG. 12 is an embodiment of a shoe 208, as described above, that uses a framework of fiber 211 embedded in an elastomeric body 213. The shoe 208 has an odd number of openings 308 formed therethrough - in this example five openings - generally equally spaced, although any suitable odd number of openings are contemplated. The openings 308 each include a sleeve 215 positioned therein, which is described in detail in connection with FIG. 13.

The fiber 211, which may be one or more of basalt, carbon fiber, fiberglass, nylon, or KEVLAR, for example, is wrapped in a figure eight pattern or oval pattern around each of the sleeves 215 as shown, from end to end of the shoe 208 once in order to allow each fiber to act in parallel, which maximizes the property of the fiber layer or layers being strongest in tension. The fiber 211 may also be wrapped around the entire circumference of each sleeve. The fibers 211 can be wrapped in multiple layers to create a selected torsional performance of the shoe 208.

The fibers 211 can be encased in a flexible elastomer such as a natural or synthetic rubber, urethane, or the like, to form the body 213. The fibers 211 operate in tension in the elastomeric body 213, which is the direction of strongest loading, and the elastomer body 213 operates in compression, the direction of its strongest loading, and also in tension in some conditions. The elastomer body 213 also acts as a damping member, protecting the fiber 211 from shock loading which could break the shoe 208.

The sleeve 215 may be generally cylindrical and hollow so as to receive a fastener therethrough, as discussed in detail above. In one example, the sleeve 215 is over molded with the elastomeric material of the body 213. The sleeve 215 may be made of metallic or nonmetallic material. The sleeve 215 should be constructed to provide sufficiently high compression strength so that fasteners can place and maintain the shoe 208 in compression, which lessens the possibility of causing the fasteners to bend from torque applied to the shoe and the fasteners, which could result in failure of the coupling.

One embodiment of a sleeve 215 is shown in FIG. 13. The sleeve 215 is generally cylindrical and is hollow. The sleeve 215 may be radially extending flanges 217 located at the ends of the sleeve and annular circumferential grooves 219 formed on an outer surface thereof to resist being pulled out of the elastomer of the body 213.

The shoe 208 of FIG. 14 includes a semi-rigid structure which may be one or more of non-fiber reinforced plastics, fiber reinforced plastics, or high stiffness elastomers, to create a framework 221 within the elastomeric body 213. The framework 221 may function as a spring, while the elastomeric portion of the shoe 208 may add damping. In this respect, the shoe 208 is unique in that it is a single part that is capable of performing two different, adjustable functions: energy storage/release and damping. Purely elastomeric structures or spring elements are unable to do both energy storage and damping due to their material properties.

The framework 221 may be comprised of a multiple of superimposed wave structures, where the shape, amplitude, and period of the waves may be tuned for a selected performance of each shoe 208. The framework 221 may also surround all of the sleeves 215.

The wave construction of the framework 221 can take any suitable form. However, in one example, the framework 221 comprises what may be considered four interconnected frame members 900 that extend longitudinally through the elastomeric body 213. All of the frame members 900 may extend from a sleeve 215 positioned adjacent a first end 902 of the shoe 208 to a sleeve positioned adjacent a second end 904 of the shoe. For clarity, while seven sleeves 215 are shown, only the first three sleeves will be referred to so as to detail the configuration of the framework, as first, second, and third sleeves and labeled respectively with reference characters 215a-c.

A first one 906 of the frame members 900 extends from sleeve 215a spanning the distance from the first sleeve 215a to the second sleeve 215b with a convex arc (a half wave), relative to the longitudinal centerline C of the shoe 208 and outside of the curvature of the centerline. From the second sleeve 215b to the third sleeve 215c the first frame member 906 takes on a concave arc (the half wave completing the remainder of a full wave) relative to the longitudinal centerline C of the shoe 208 and outside of the centerline. The second one 908 of the frame members 900 has the form of a wave that is 180 degrees out of phase relative to the first one 906 of the frame members and also positioned outwardly of the curvature of the centerline C.

Similarly, the third one 910 of the frame members 900 extends from sleeve 215a spanning the distance from the first sleeve 215a to the second sleeve 215b with a concave arc (a half wave), relative to the longitudinal centerline C of the shoe 208 and inside of the curvature of the centerline. From the second sleeve 215b to the third sleeve 215c the third frame member 910 takes on a convex arc (the half wave completing the remainder of a full wave) relative to the longitudinal centerline C of the shoe 208 and inside the curvature of the centerline. The fourth one 912 of the frame members 900 has the form of a wave that is 180 degrees out of phase relative to the third one 910 of the frame members and also positioned inwardly of the curvature of the centerline C. Generally, without being limited thereto, in one embodiment, the shape of the frame members may be trigonometry based and may resemble a sine wave, or in another embodiment, a cosine wave.

Since the arc segments of the frame members 900 interconnect at a position adjacent each of the sleeves 215 they do not act entirely independently of each other and so may be considered to form a framework that shares loads depending on forces experienced by the shoe 208.

Construction of the shoe 208 as shown, places the encased flexible elastomer body portion 213, made of one or more of synthetic rubber, natural rubber, urethane, or the like, in compression, whether the shoe is placed in tension or compression. Accordingly, each component of the shoe 208 is placed in the most desirable direction of loading, whereby the frame structure 221 is loaded in tension or compression, and the elastomer 213 is loaded in compression. The elastomer 213 also acts as a damping member, protecting the semi rigid frame 221 from shock loading which could break the shoe.

The shoe 208 of FIG. 15 is constructed of similar materials, but with a different shape of framework 223 and a different shape of the elastomeric body 225. The shoe 208 may use a semi rigid framework structure 223 which may be constructed of one or more of non-fiber reinforced plastics, fiber reinforced plastics, or high stiffness elastomers, to create a framework which functions as a spring. This framework 223 is comprised of a multiple of superimposed waves, which may be trigonometry based shapes, where the amplitude and period of the waves is tuned for a selected performance. The shoe 208 places the encased flexible elastomer portion 213 such as one or more of synthetic rubber, natural rubber, urethane, or the like, in compression whether the shoe is placed in tension or compression. Accordingly, each component of the shoe 208 is placed in the most desirable direction of loading, whereby the frame structure 223 is loaded in tension or compression, and the elastomer 213 is loaded in compression. The elastomer 213 also acts as a damping member, protecting the semi rigid frame 223 from shock loading which could break the shoe 208. Depending on the material selected for construction of the frame 223, the inserts or sleeves may be formed by the frame itself, and separate inserts or sleeves may be omitted.

Another feature of the embodiment of FIG. 15 is the configuration of the inner and outer surfaces 227, 229 of the shoe 816 that each have a plurality of scalloped or planar facets 231. The scalloped or planar facets 231 allow the sections of the shoe 816, each generally extending between the centers of the openings 308, to act as individual columns, increasing the amount of fabric placed in perfect tension and elastomer in compression. The circular design, as shown in FIG. 14 may be used for less torque carrying capacity.

FIG. 16 shows a close up cross section of a shoe 208 and a misaligned coupling. In particular, the outer peripheral surface 233 of the shoe is convex, which allows for an increased angular misalignment of the flanges 202A, 204A, while maximizing the damping afforded by the elastomeric portion of the shoe. Fastener 302 is fixed to flange part 203A, extends through sleeve 215 of the shoe 208, and therefore the shoe itself, and extends into the bore opening 304 of the flange 202A without being fixed to the flange 202A. Because the fastener 302 holds the sleeve 215 in contact with flange 204A during misalignment, the shoe 208 stays aligned and in contact with the flange 204A, while flange 202A assumes an angular displacement relative to flange 204A. The shoes 208, 816 are supplied as at least two, separate torque transfer elements for a coupling assembly for ease of assembly.

Turning to FIG. 17, the bore openings 304 may have a generally elongated or elliptical shape that accommodates the head of the fastener 302. The bore openings 304 may be other suitable shapes such as oval, for example, with the greater dimension of the openings aligned in the same orientation as that of the elliptical shape depicted, a slot with circular ends, and the like. The shape of the bore openings 304 accommodates movement of the head of the fastener 302 relative to the thru-flange portion 202A. In particular, the shape of the bore openings 304 may accommodate motion of the head of the fastener 302 of a greater extent in an arc parallel to the outer circumferential shape of the flange portion 202A compared to a radial direction. While misalignment may cause some movement in a radial direction, it will be understood that due to the torsional forces being transferred by the coupling and the resilience of the shoes that rotational displacement may occur at least temporarily during operation between various parts of the coupling.

One example of in-cut trough formed at the base of each tooth 210, generally referred to as the tooth fillet, of the flange portion 202A is also shown in FIG. 17. The in-cut feature may be applied to all or some of the flanges 202, 204, or to portions of the flanges. The front and rear faces of each tooth 210 may be convex and each root 1400 formed between each tooth may be characterized by a flat or convex root surface 1402 flanked by an opposed pair of concave corners 1404 formed at the base of each face of each tooth. The concave corners 1404 have a greater radius than a standard root fillet to allow for ease of installation onto a splined shaft with teeth 108 and to provide greater strength and resilience, for example, by avoiding sharp corners that may act as stress concentrators. The shape of the teeth 210 and root 1400 permits the use of a large variety of materials for the flanges, for example, injection molded plastic, which would reduce material cost and/or weight of the flanges and thus, the coupling.

FIG. 18 illustrates flange teeth 1410, which have a generally triangular shape with predominantly flat front and rear tooth faces. The root portions of the teeth are generally circular in cross section. Adjacent pairs of teeth 1410 are spaced apart by a trough 1412 with a large radii or arcuate shape that is deeper than the spline teethreach. Standard troughs or bottom lands are typically flat. The troughs 1412 provide another example of a configuration that eases installation while maximizing spline tooth 108 strength.

FIG. 19 illustrates a shaft 104 with flanges 202A, 204B attached by clamp bolts 1416. Each of the flanges 202A, 202B (and corresponding shaft and flanges for the opposite part of the coupling) may be connected to the shaft 104 by the bolts 1416 to prevent axial movement of the flanges on the shaft and keep the coupling together in the event of a part failure. The bolts 1416, for example numbered two per each flange portion 202A, 204B are inserted through each flange portion radially into the shaft 104. The tolerances of the fit of the flange parts of the coupling to the shafts may be less exacting by using the clamp bolts 1416, thereby lowering the manufacturing cost of the coupling.

FIG. 20 shows teeth 1410 of a flange (202A, for example) spaced asymmetrically for more even loading. It has been found that symmetrical spacing of the teeth 1410 produces uneven loading, wherein the highest loads are seen in the centrally located teeth (at “12:00 O'clock” or halfway between the ends of the semi-circular flange) in this figure. The lowest loading (approximately half that of the centrally located teeth) are found at the ends of the semi-circular flange (at 9:00 and 3:00 O’clock in this figure). It will be understood that even loading of all teeth 1410 would permit the use of materials alternative to metal, permit smaller overall couplings, and/or extend the useful life of the coupling. In one example, the teeth 1410 are spaced or sized with more clearance or spacing in the central span of the flange and less clearance in the lateral or ends of the flange. In other words, the pitch of the teeth can be configured such that when clamped together, the teeth are all loaded equally.

FIG. 21 shows a cover 1406 that is shaped and sized to surround or shroud the coupling assembly 100, the flanges (flanges 202A, 204A shown), and shafts 102, 104. The cover 1406 protects the entire assembly 100 from exposure to chemicals and physical impact. In one embodiment, the cover 1406 is configured to hold a pair of spaced apart seals, for example O-rings, respectively against shafts 102, 104 to exclude contaminants from entering the interior of the coupling assembly 100. A mating (top) half of the cover 1406 is shown removed for illustration but is arranged to cover the remaining or exposed portions of the coupling assembly 100 shown herein to completely enclose the flanges and resilient shoes operating therein.

FIGS. 22-25 show flanges with splines 1410 that extend the entire axial length of the flanges 1450, 1452 of a coupling assembly. Flanges 1450, 1452 of FIG. 22 may be held together with fasteners 1454, such as bolts and nuts. In this embodiment, the flanges 1450, 1452 are retained axially in position by stop plates 1456, which are positioned on the side of the flange that include the nut portion of the fastener 1454 and captured thereby. Use of the flanges 1450 and fasteners 1454 renders use of the stop wall 214 as described below unnecessary for some embodiments.

As shown in FIG. 23, mated pairs of flanges 1450, 1460 and 1452, 1462 are each held together by dovetail joints as an alternative, or in addition to, to nut and bolt fasteners or threaded fasteners as described and shown in other embodiments, for example, in reference to FIG. 6. Other types of positive engagement configurations may be used to fasten the mated pairs of flanges 1450, 1460 and 1452, 1462.

FIG. 24 shows a flange 1470 where the teeth 1410 extend the entire axial length of the flange. In this embodiment, the flange 1470 includes a recess 1472 that is shaped and sized to receive a shoe 208. Alternatively, as shown in FIG. 26, a flange 1474 has teeth 1410 that extend only part of the axial length of the flange. In this embodiment, the flange 1474 is employed as a stop flange portion as disclosed in detail above. FIG. 26 is a flange 1480 that replaces the teeth in the previous embodiments that engage the splines of a conventional shaft with an alternative connecting feature. The flange 1480 is similar in construction as the stop flange of FIG. 26, but replaces the teeth with a plurality of spaced, axially extending teeth, dowels, or pins 1482 that are positioned on the flange so as to engage with corresponding splines of a flanged shaft (not shown) when assembled thereto. The pins 1482 may be cylindrical, oval, rectangular, or any suitable shape in cross section that enable engagement with a splined shaft. In one embodiment, instead of splines, the flanges may form bores or openings that accommodate the pins 1482.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The term “configured” used herein refers to a specified structure, shape and/or size.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A coupling assembly for transmitting rotational forces between a driving shaft and a driven shaft, said driving and driven shafts having teeth for attachment of said coupling assembly thereto, said coupling assembly comprising:
an annular first flange sized and shaped to be positioned radially outwardly with respect to the driving shaft, the first flange having a plurality of teeth on an inner portion thereof configured to engage with the teeth of the driving shaft so as to rotationally fix the first flange to the driving shaft;
an annular second flange sized and shaped to be positioned radially outwardly with respect to the driven shaft, the second flange having a plurality of teeth on an inner portion thereof configured to engage with the teeth of the driven shaft so as to rotationally fix the second flange to the driven shaft;
a pair of elastomeric shoes configured to be disposed between the first flange and second flange;
wherein the pair of elastomeric shoes are configured to be attached to the coupling assembly by way of a first plurality of fasteners that are fixed to the first flange and extend through the pair of elastomeric shoes to connect the pair of elastomeric shoes to the first flange; and
a second plurality of fasteners that are fixed to the second flange and extend through the pair of elastomeric shoes to connect the pair of elastomeric shoes to the second flange;
wherein, when so attached, the pair of elastomeric shoes are thereby configured to transmit torque from the first flange to the second flange and permit misalignment between the driving shaft and the driven shaft.

2. The coupling assembly of claim 1 wherein each of the pair of shoes includes an odd number of holes formed therethrough.

3. The coupling assembly of claim 2 further comprising a sleeve disposed in each of the holes.

4. The coupling assembly of claim 2 wherein each of the pair of shoes further comprises a framework.

5. The coupling assembly of claim 4 wherein the framework comprises one or both of fiber or fabric.

6. The coupling assembly of claim 5 wherein the fiber or fabric includes one or more of basalt, carbon, fiberglass, nylon, or aramid material.

7. The coupling assembly of claim 4 wherein the framework includes one or more of non-fiber reinforced plastic, fiber reinforced plastic, or high stiffness elastomers.

8. The coupling assembly of claim 7 wherein the framework is configured as trigonometry based wave structures.

9. The coupling assembly of claim 4 further comprising a sleeve disposed in each of the holes and wherein the framework surrounds each of the sleeves.

10. The coupling assembly of claim 1 wherein the first flange includes bore openings for receiving heads of the second plurality of fasteners, the second flange includes bore openings for receiving heads of the first plurality of fasteners, the size and shape of the bore openings permitting relative movement between the heads and respective bore openings.

11. The coupling assembly of claim 10 wherein the bore openings are elliptical.

12. The coupling assembly of claim 1 wherein the base of each tooth of the first flange and the second flange is in-cut.

13. The coupling assembly of claim 1 wherein each adjacent pair of teeth of the first flange and the second flange has an arcuate trough.

14. A resilient shoe for transmitting rotational forces between flanges of a coupling assembly fixed to a driving shaft and a driven shaft, the shoe comprising:
an arcuate body made of an elastomeric material;
a plurality of spaced-apart holes formed through the shoe, the plurality of holes provided in an odd number;
a sleeve disposed in each of the plurality of holes, each sleeve configured to receive a fastener therethrough and configured to reinforce the one of the pluralities of holes in which it is disposed; and
a framework disposed in the elastomeric material configured to be placed in tension or compression in response to torque transmitted through the coupling assembly.

15. The resilient shoe of claim 14 wherein the shoe forms a minor arc.

16. The resilient shoe of claim 14 wherein a segment is defined between each adjacent pairs of holes, wherein each segment is configured as a column.

17. The resilient shoe of claim 14 wherein the sleeves are made of a non-compressible material.

18. The resilient shoe of claim 17 wherein the sleeves are made of metal, plastic, or a composite.

19. The resilient shoe of claim 14 wherein the framework comprises one or both of fiber or fabric disposed about each of the sleeves.

20. The resilient shoe of claim 19 wherein the framework comprises one or both of fiber or fabric extending between the sleeves.

21. The resilient shoe of claim 20 wherein the fiber includes one or more of basalt, carbon, fiberglass, nylon, or aramid material.

22. The resilient shoe of claim 14 wherein the framework includes one or more of non-fiber reinforced plastic, fiber reinforced plastic, or high stiffness elastomers.

23. The resilient shoe of claim 22 wherein the framework is comprised of trigonometry based wave structures.
